(19) United States
(12) Patent Application Publication
(10) Pub. No.: US 2018/0341870 A1
(43) Pub. Date: Nov. 29, 2018

(54) Managing Indecisive Responses During a Decision Tree Based User Dialog Session

(71) Applicant: International Business Machines Corporation, Armonk, NY (US)

(72) Inventors: Sachindra Joshi, Gurgaon (IN); Harshit Kumar, Delhi (IN); David Nahamoo, Yorktown Heights, NY (US)

(21) Appl. No.: 15/602,370

(22) Filed: May 23, 2017

(51) Int. Cl. G06N 5/04; G06F 17/30

(52) U.S. Cl. CPC G06N 5/045; G06F 17/30961

(57) ABSTRACT

An approach is provided in which a system provides a question and a set of options to a user. The question corresponds to a first node in a decision tree and at least a portion of the options correspond to nodes that are directly connected to the first node. The system determines that the user's response corresponds to a second node that is different than one of the directly connected nodes and, in turn, displays a second question to the user corresponding to the second node.

### BACKGROUND

Today's computer systems employ user dialog sessions to assist a user in performing tasks such as software installation, system configuration, etc. At times, a user may be unsure as to which option to select for a particular question in the user dialog session. In these situations, the user either randomly chooses an option or exits the user dialog session altogether.

When the user randomly chooses an option and later changes his/her mind, the user typically is required to start a new user dialog session because the user is not allowed to “back track” steps in the user dialog session. In a large decision tree, this may require the user to re-enter several answers until the user reaches the point at which the user wishes to enter a different option than what was entered during the first user dialog session. In addition, if the system automatically chooses an option on behalf of the user and the user does not like the system's selection, the user is unable to request the system to select a different option.

### BRIEF SUMMARY

According to one embodiment of the present disclosure, an approach is provided in which a system provides a question and a set of options to a user. The question corresponds to a first node in a decision tree and at least a portion of the options correspond to nodes that are directly connected to the first node. The system determines that the user's response corresponds to a second node that is different than one of the directly connected nodes and, in turn, displays a second question to the user corresponding to the second node.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment

FIG. 3 is an exemplary diagram depicting an information handling system that manages indecisive responses from a user during a decision tree-based user dialog;

FIG. 4 is a diagram depicting an example of a decision tree whose nodes are assigned a specific identifier to track states in a local conversation stack;

FIG. 5 is a diagram depicting a user dialog on a browser and underlying local conversation stack state progressions;

FIG. 6 is a diagram depicting a user dialog on a browser and underlying local conversation stack state progressions when a user wishes to jump back to an anchor node;

FIG. 7 is a diagram depicting a user dialog that includes a dialog manager selecting an answer for a user the user selecting a different answer;

FIG. 8 is a diagram depicting a user dialog on a browser and underlying local stack progressions when a user provides an indecisive response that invokes dialog manager 310 to move to a different decision tree;

FIG. 9 is a diagram depicting state progressions of a global conversation stack; and

FIG. 10 is a flowchart showing steps taken by a dialog manager to dynamically manage a user dialog when the user provides indecisive responses to answers.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

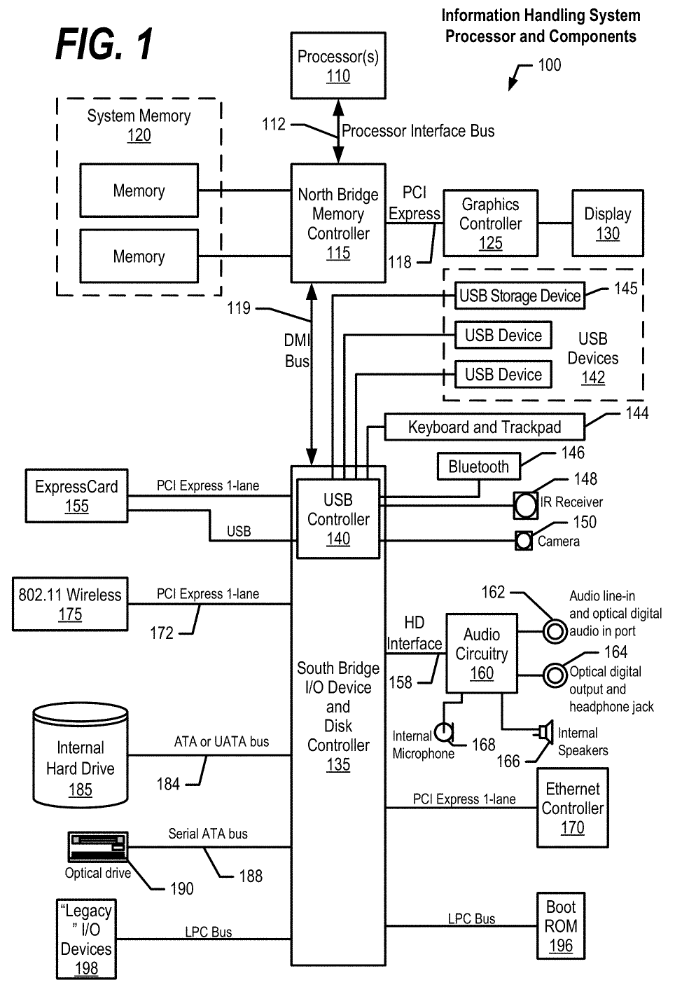

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

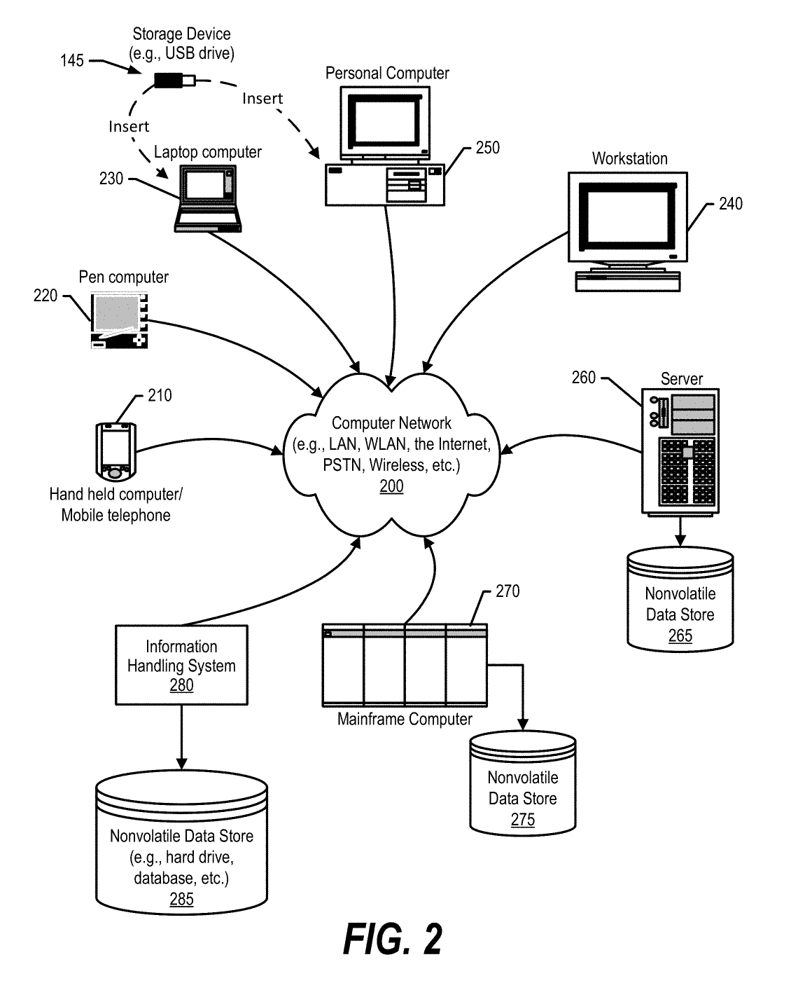

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

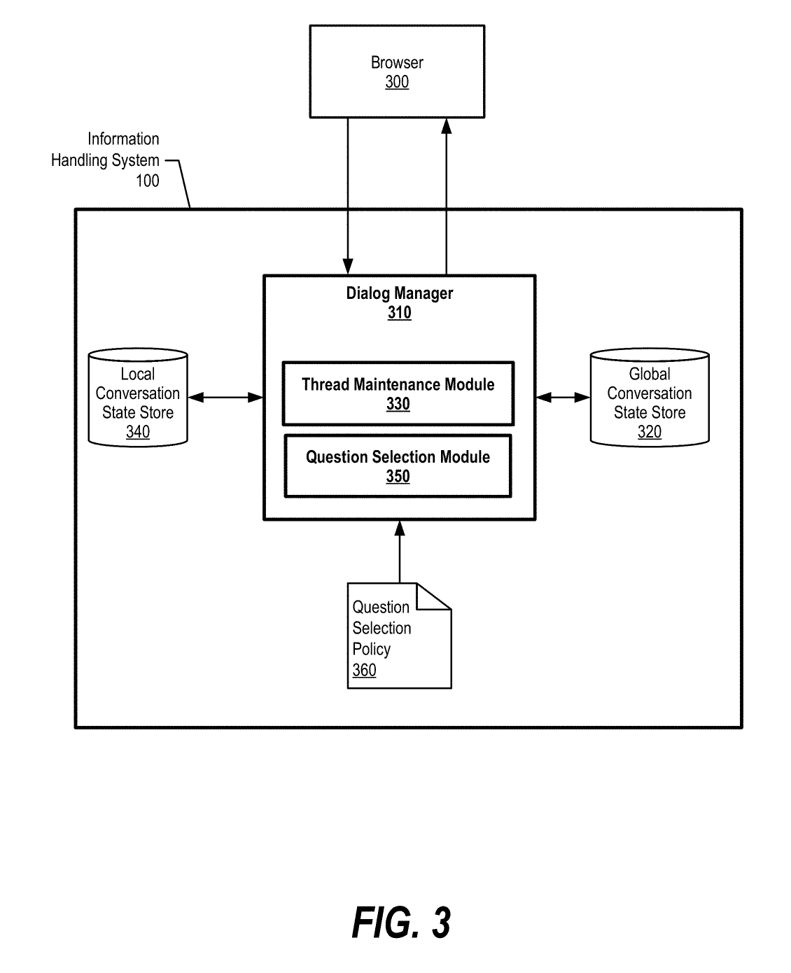

FIGS. 3 through 10 depict an approach that can be executed on an information handling system to manage indecisive responses from a user during a decision tree-based user dialog. To mitigate the limitations with today's decision tree-based dialogs, the information handling system disclosed herein provides enhanced capabilities that allow a user to provide indecisive responses to a question in a dialog session. The indecisive response are responses that do not correspond to branches from a current node to a child node. The information handling system allows a user to perform selections such as “Take me back one layer” to move back a node when the user has changed his mind; “Take me somewhere else” when a user doesn't like the information handling system's selection and would like to try other options; “Jump back to anchor node” when the user wishes to move back to a user-selectable anchor node, and also allows a user to enter free-form text when the user requires additional information to select a particular option, which may take the user to a different decision tree altogether. In addition, the information handling system provides visual position indicators on a browser screen so the user is aware of the user's current location in a decision tree.

FIG. 3 is an exemplary diagram depicting an information handling system that manages indecisive responses from a user during a decision tree-based user dialog. Information handling system 100 includes dialog manager 310, which interfaces with browser 300 to provide a decision tree-based dialog user interface. As discussed herein, dialog manager 310 provides a series of decision tree-based questions to a user to assist the user in answering a question or performing a task. The user, at times, may provide an indecisive response to dialog manager 310 when the user is unsure of an answer to a particular question. Dialog manager 310, in turn, analyzes the user's indecisive response and redirects the user dialog accordingly.

Dialog manager 310 receives an initial question from a user through browser 300, such as “How do I install software X on my computer?” Dialog manager 310 analyzes the question, such as by using natural language processing techniques, and selects a decision tree that matches the initial question. As discussed herein, dialog manager 310 uses local conversation stacks and a global conversation stack to manage states of local conversation states and global conversation states, respectively. Local conversation stacks track the current states within individual decision trees (e.g., node location), whereas the global conversation stack tracks the states of the decision trees (e.g., active decision trees, suspended decision trees, etc.), stored in global conversation state store 320.

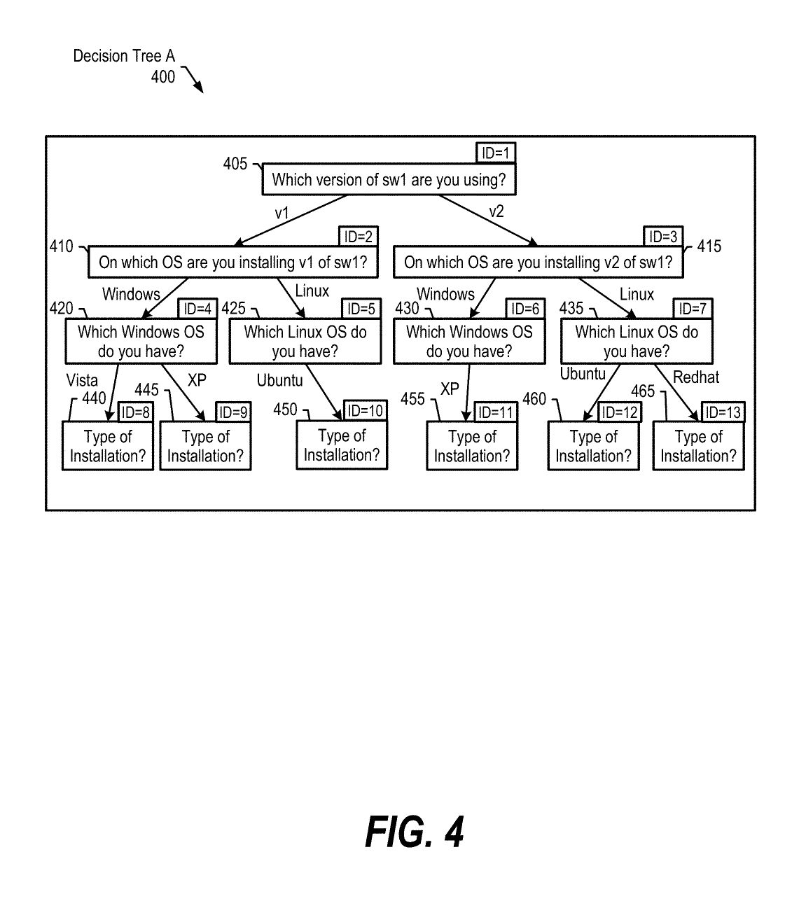

Dialog manager 310 identifies a node within the selected decision tree corresponding to the questions, such as its root node, and presents a question and possible options to the user. The question corresponds to the identified node and the options correspond to branches from the node. Referring to FIG. 4, dialog manager 310 may select decision tree A 400's root node 405 and provide possible answers that will branch to node 410 or 415 depending on the user's response.

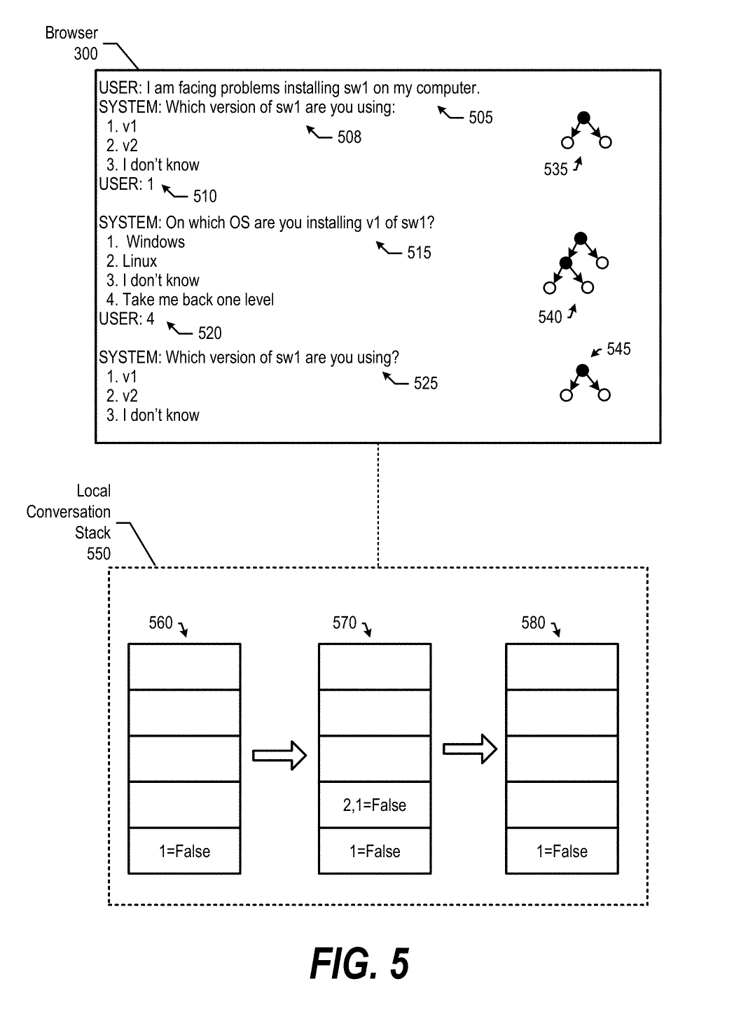

Dialog manager 310 receives a response from the user and, if the user selects an answer corresponding to a branch to a child node, dialog manager 310 uses thread maintenance module 330 and question selection module 350 to update the local conversation state in local conversation state store 340 and provide a next question corresponding to the next node based on question selection policy 360. Thread maintenance module 330 maintains a stack of visited nodes and active nodes, and question selection module 350 selects the next best question to ask such that the number of turns to arrive at end solution is minimum. Referring to FIG. 5, the user is presented with question 508 and the user selects option “1” (response 510). As such, dialog manager 310 asks the next question 515, which corresponds to node 410 in FIG. 4. However, when the user provides an indecisive response that does not correspond to a branch from the node to a child node, dialog manager 310 analyzes the indecisive response and jumps to a node within the current decision tree or jumps to a different decision tree altogether (see FIGS. 5 through 10 and corresponding text for further details).

FIG. 4 is a diagram depicting an example of a decision tree whose nodes are assigned a specific identifier to track states in a local conversation stack. Decision tree A 400 is used by dialog manager 310 to provide guidance to a user to install software on the user's system. Each of nodes 405, 410, 415, 420, 425, 430, 435, 440, 445, 450, 455, 460, and 465, include a node identifier (e.g., ID=1, ID=2, etc.), which dialog manager 310 uses in a local conversation stack corresponding to decision tree A 400 to track its state (see FIGS. 5-7 and corresponding text for further details).

Question selection module 350 is responsible for selecting the next best question to ask such that the number of steps to arrive at an end solution is minimum. For example, a user may input “I am having problem installing sw1 on Ubuntu,” which matches two nodes in the decision tree, id=5 and id=7. This means that both the left subtree and the right subtree following the root node id=1 are active and require disambiguation. Question selection module 350 determines the next question to ask in order to resolve the disambiguation such that that number of turns to arrive at an end solution is minimum. Question selection module 350 determines that the best question to ask in this scenario is the version of sw1, id=1 to resolve the disambiguation. The system asks “Which version of sw1 are you using?” and the user response will be either v1 or v2, resulting in either the left subtree or right subtree becoming active. If user responds with v1, then question selection module 350 needs to determine the next best question, which in this case is question association with id=10 because the user already specified that the user is using Ubuntu. And, if the user responds with v2, then question selection module 350 determines that the next best question is id=12 because the user already specified that the user is using Ubuntu.

FIG. 5 is a diagram depicting a user dialog on a browser and underlying local conversation stack state progressions. Dialog manager 310 receives an initial question and displays the initial question 505 on browser 300, which is “I am facing problems installing sw1 on my computer.” Referring to FIG. 4, dialog manager 310 access decision tree A 400 and displays question 508 (corresponds to node 405). In addition, dialog manager 310 displays position indicator 535 that shows the user's decision tree location is at the top root node. The user provides response 510 and dialog manager 310 displays the next question based on decision tree A 400. Dialog manager 310 also displays corresponding position indicator 540.

At this point, the user realizes that the user is traveling down the wrong decision tree branch and provides indecisive response 520, which is “take me back one level.” As such, dialog manager 310 moves back up the decision tree, displays position indicator 545, and re-asks question 525.

FIG. 5 also shows the progression of a local conversation stack 550 that corresponds to decision tree A 400. In the beginning the stack is empty and dialog manager 310 receives initial question 505. Dialog manager 310 displays question 508 and adds an entry, “1=False” into the stack (state 560). The entry, 1=False, means that the node id=1 (in FIG. 4) has been visited. The user must choose one of the following options: 1 (v1 for node id=2), 2 (v2 for node id=3) and 3. The user chooses option 1 (response 510) corresponding to v1 for node id=2. In turn, the entry “2,1=False” is pushed onto the stack (state 570). The entry, 2,1=False, means that node id=2 has been visited by the user, and the path to node id=2 had been through node id=1. Dialog manager 310 stores each push into the stack the information about the node that has been visited by the user and the path to that node. An entry with a value “True” means that the node has not been visited yet.

Next, the user chooses option 4 (response 520) and dialog manager 310 interprets the input=4 as go back one step. Dialog manager 310 removes an entry from the stack (state 580); evaluates the item from the top of the stack, and extracts the first node id from the comma delimited list (ID=1). The extracted node id is used to identify the node and next question to be posed to the user (question 525).

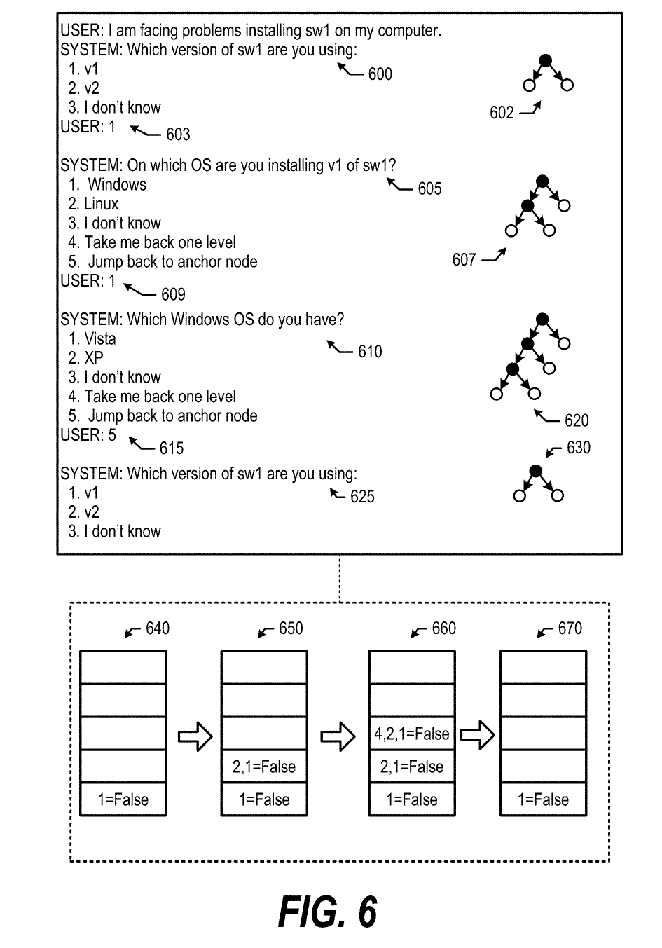

FIG. 6 is a diagram depicting a user dialog on a browser and underlying local conversation stack state progressions when a user wishes to jump back to an anchor node. In one embodiment, top-level decision tree nodes may be anchor nodes by default. In another embodiment, dialog manager 310 may allow a user to select their own anchor nodes, such as specifying anchor nodes every three layers down a decision tree in a large decision tree.

Dialog manager 310 initiates a dialog with a user that starts with question 600; displays position indicator 602; and adds an entry to the local conversation stack (state 640). The user selects option “1” (response 603) and dialog manager 310 provides question 605; displays position indicator 607; and adds an entry to the local conversation stack (state 650).

The user provides response 609. In turn, dialog manager 310 displays question 610 and corresponding position indicator 620, and adds an entry to the local conversation stack (state 660) indicating that the user is at a node with ID=4 (see FIG. 4). The user at this point believes that the user is traveling down the wrong path and provides response 615, which is “Jump back to anchor node.” Dialog manager 310, in turn, jumps back to the closest anchor node (e.g., top-level node); displays question 625 and corresponding position indicator 630, and updates the local conversation stack accordingly (state 670).

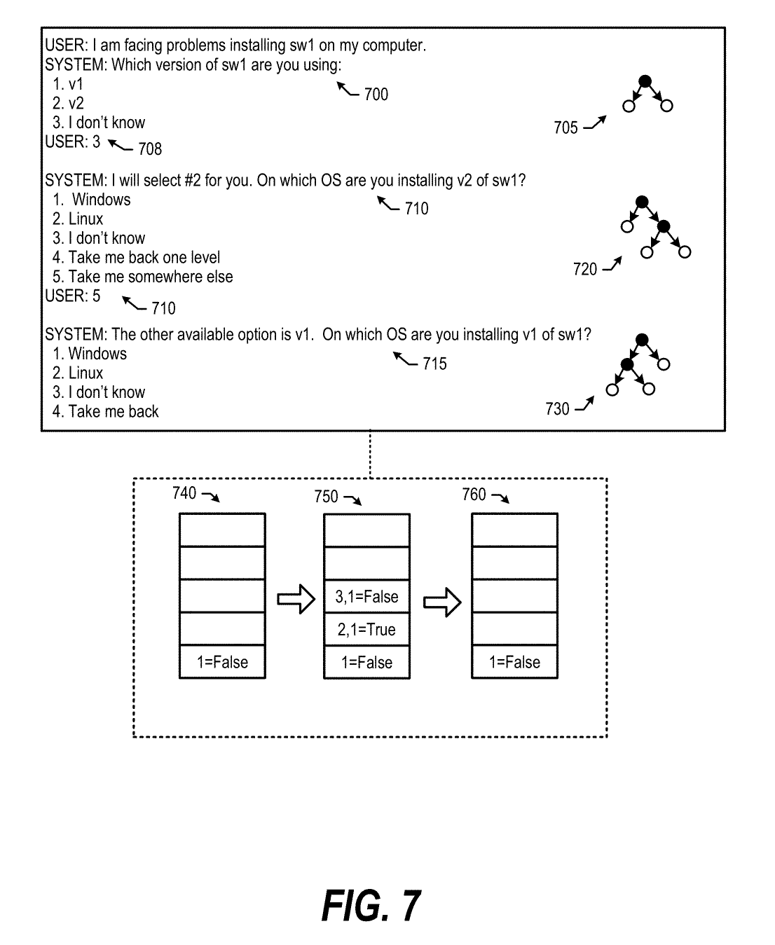

FIG. 7 is a diagram depicting a user dialog that includes a dialog manager selecting an answer for a user the user selecting a different answer. Dialog manager 310 provides a dialog to a user that begins with question 700. Dialog manager 310 displays position indicator 705 and adds an entry to the local conversation stack (state 740). The user selects option “3” (response 708), which is an indecisive response. As such, dialog manager 310, in one embodiment, identifies a most common answer to question 700. Dialog manager 310 then displays question 710 with an explanation along with position indicator 720. Dialog manager 310 also updates the local conversation stack (state 750).

The user determines that dialog manager 310 is on a wrong path and provides response 710, which is “Take me somewhere else.” Dialog manager 310, in turn, selects a different answer to question 700, displays question 715 and corresponding position indicator 715, and updates the local conversation stack by removing specific entries (state 760) back to the entry that has a “TRUE” entry.

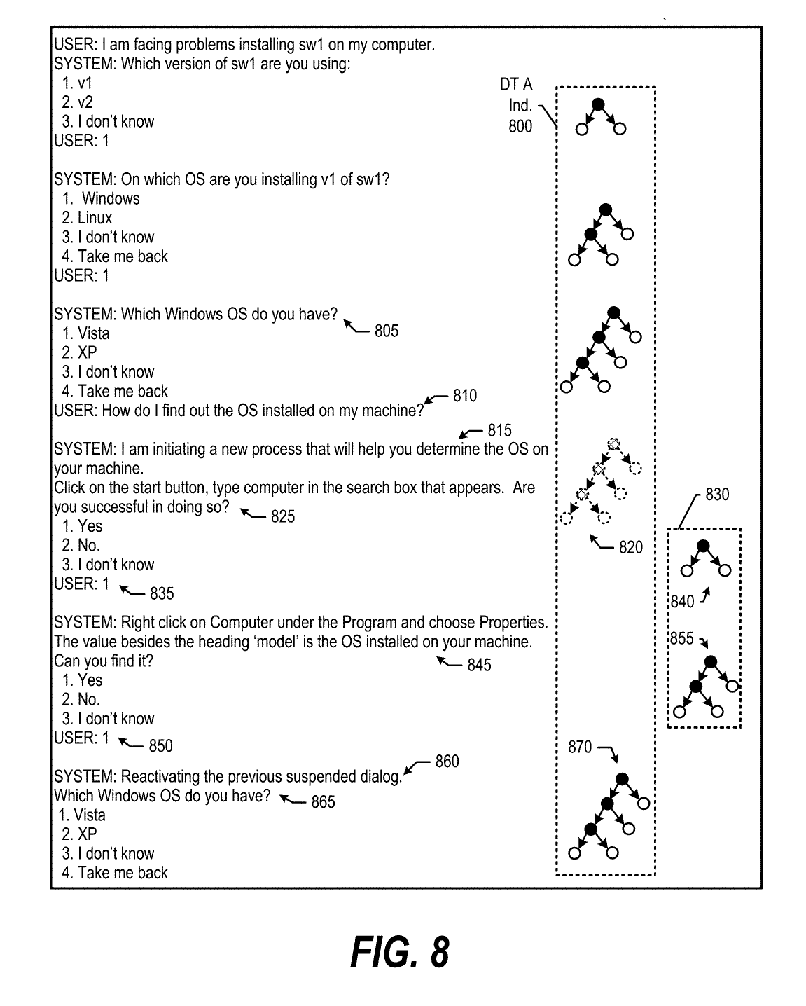

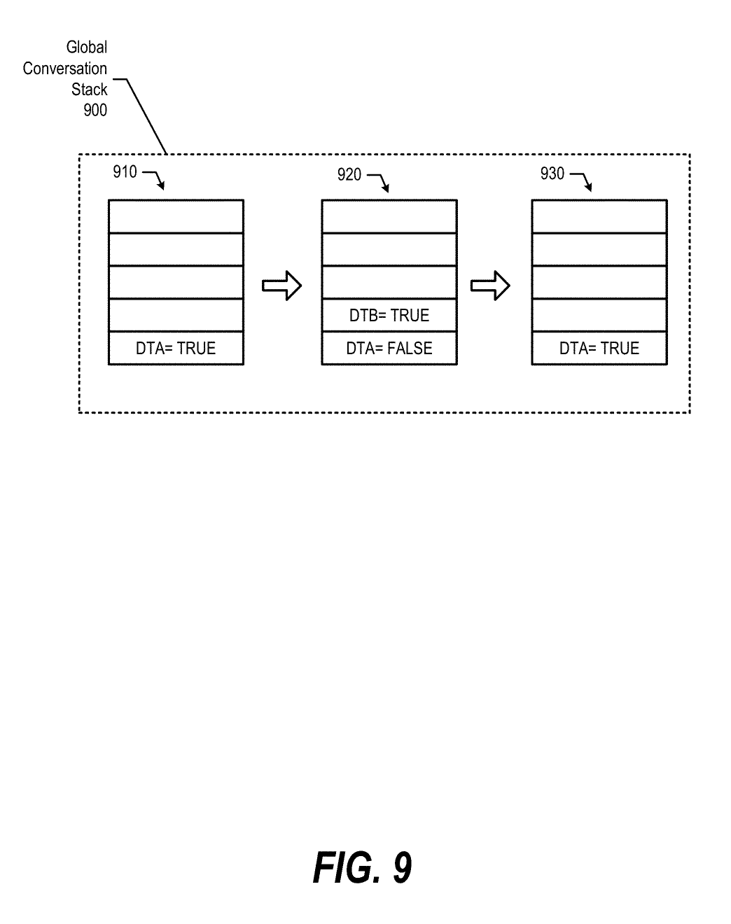

FIG. 8 is a diagram depicting a user dialog on a browser and underlying local stack progressions when a user provides an indecisive response that invokes dialog manager 310 to move to a different decision tree. As discussed below, a user may input text as an input to a question (input 810) to obtain further information. In this embodiment, dialog manager 310 compares the input to the current decision tree and, if the text input does not match any of the nodes on the current decision tree, dialog manager 310 matches the text input to other nodes on other decision trees. When dialog manager 310 matches the text input to a node on a different tree, dialog manager 310 modifies the global conversation stack to indicate that the current decision tree is suspended and a different decision tree is activated (see FIG. 9 and corresponding text for further details).

A user asks an initial question and dialog manager 310 proceeds through a dialog on a selected decision tree as discussed earlier. Position indicators 800 correspond to decision tree A 400. Referring to FIG. 9, dialog manager 310 adds an entry into global conversation stack 900 indicating that decision tree A 400 is active (state 900).

At some point, the user is uncertain of how to answer a question (question 805), and enters an indecisive response accordingly (response 810). Dialog manager 310 first attempts to match response 810 to nodes of the current decision tree. If no nodes match, dialog manager 310 then matches response 810 to a different decision tree (decision tree B).

Dialog manager 310 informs the user that dialog manager 310 is initiating a new process (notice 815). Dialog manager 310 also suspends the current decision tree and displays position indicator 820 in manner that indicates the decision tree is in a suspended state (e.g., dashed lines). In addition, referring to FIG. 9, dialog manager 310 modifies global conversation stack 900 (state 920) to indicate that decision tree A is suspended (DTA=FALSE) and decision tree B is active (DTB=TRUE).

Dialog manager 310 then provides information and a question (825) from the new decision tree (decision tree B) while also providing decision tree position indicators 830 for the different decision tree (840). Dialog manager 310 then asks question 845 based on the user's response 835 and displays position indicator 855 accordingly.

The user provides response 850, indicating to dialog manager 310 that the user is now informed to answer question 805 from the first decision tree. As such, dialog manager 310 evaluates global conversation stack 900 to determine to reactivate decision tree A and modify global conversation stack 900's state accordingly (state 930). In turn, dialog manager 310 displays position indicator 870, informs the user that dialog manager 310 is reactivating the first decision tree (860), and asks a question (865) based on decision tree A's local conversation stack.

FIG. 9 is a diagram depicting state progressions of a global conversation stack. As discussed above, dialog manager 310 uses global conversation stack 900 to track active and suspended decision trees as dialog manager 310 manages a user dialog.

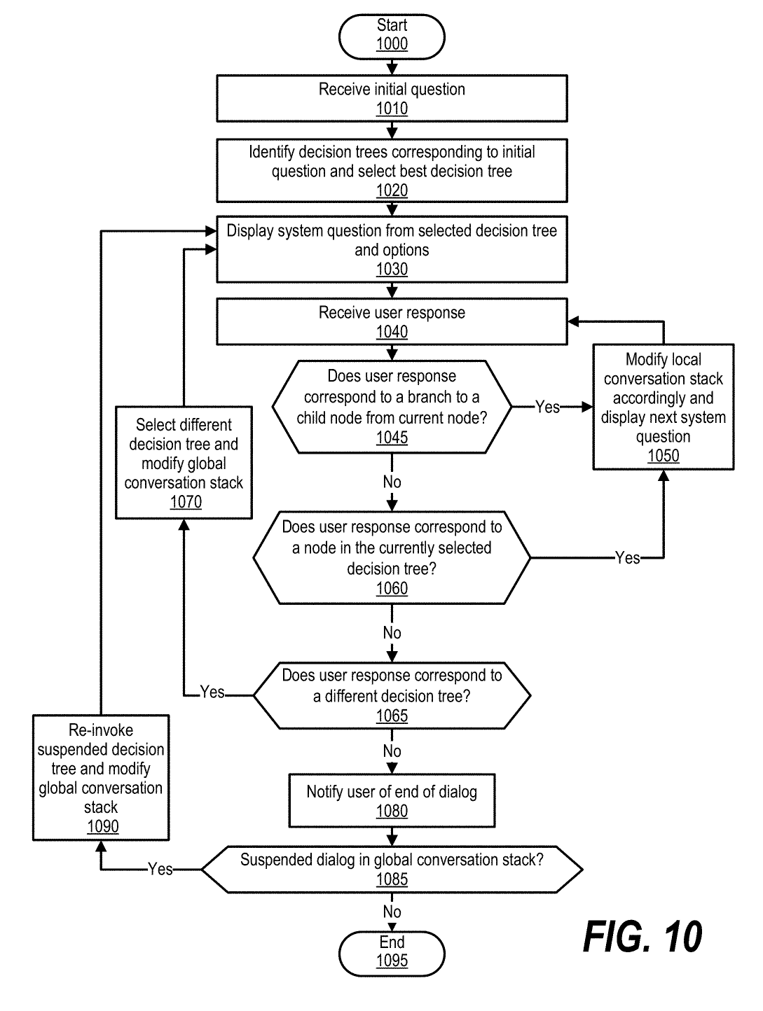

FIG. 10 is a flowchart showing steps taken by a dialog manager to dynamically manage a user dialog when the user provides indecisive responses to answers. FIG. 10 processing commences at 1000 whereupon, at step 1010, the process receives an initial question from a user through browser 300. At step 1020, the process identifies decision trees corresponding to the initial question and selects a best matching decision tree. In one embodiment, the process performs natural language processing steps to match the user's initial question to a specific decision tree.

At step 1030, the process displays a system question from the selected decision tree and, at step 1040, the process receives a user response. A determination is made as to whether the response corresponds to a branch to a child node (decision 1045). Referring to FIGS. 4 and 5, question 508's options 1 and 2 correspond to branches to FIG. 4's child nodes 410 and 415. As such, if the user selects option 1, the process branches from node 405 to node 410. If the user's response corresponds to a branch to a child node from the current node, then decision 1045 branches to the “Yes” branch whereupon the process modifies the decision tree's local conversation stack and displays the next system question corresponding to the targeted child node (step 1050).

On the other hand, if the user response dies not correspond to a branch to a child node from the current node, then decision 1045 branches to the “No” branch. A determination is made as to whether the user response corresponds to a node in the currently selected decision tree, such as “Jump to anchor node” or “Take me back one level” (decision 1060). If the user response corresponds to a node in the currently selected decision tree, then decision 1060 branches to the “Yes” branch whereupon the process modifies the decision tree's local conversation stack and displays the next system question corresponding to the targeted node (step 1050).

On the other hand, if the user response does not correspond to a node in the currently selected decision tree, then decision 1060 branches to the “No” branch whereupon a determination is made as to whether the user response corresponds to a different decision tree (decision 1065). If the user response corresponds to a different decision tree, then decision 1065 branches to the “Yes” branch whereupon the process suspends current the current decision tree while keeping its state in its local conversation stack, selects a different decision tree, and modifies the global conversation stack accordingly as described herein.

On the other hand, if the user response does not correspond to a different screen, such as “Exit the dialog,” then decision 1065 branches to the “No” branch whereupon the process notifies the user that the dialog is ending for the current decision tree (step 1080). A decision Is made as to whether the global conversation stack includes entries of suspended dialogs from other decision trees (decision 1085). If the global conversation stack includes the entries, then decision 1085 branches to the “Yes” branch whereupon the process loops back to re-invoke the suspended decision tree and removes the entry from the global conversation stack at 1090. This process continues until there are no more entries in the global conversation stack that correspond to suspended decision trees, at which point decision 1085 branches to the “No” branch whereupon processing thereafter ends at 1095.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
providing a question and a set of answer selections to a user, wherein the question corresponds to a first node in a decision tree, and wherein at least a portion of the set of answer selections corresponds to a branch from the first node to one of a plurality of connecting nodes that directly connect to the first node;
analyzing a user response to the question, wherein the user response corresponds to a second node that is different than one of the plurality of connecting nodes; and
displaying a second question to the user that corresponds to the second node.

2. The method of claim 1 wherein, prior to providing the question and the set of answer selections to the user, the method further comprises:
evaluating a request received from the user against a plurality of decision trees, wherein each of the plurality of decision trees includes a plurality of nodes; and
selecting the decision tree from the plurality of decision trees and the first node from the plurality of nodes based on the evaluation of the request.

3. The method of claim 1 further comprising:
displaying a position indicator to the user that identifies a position of the second node in the decision tree.

4. The method of claim 1 wherein the analyzing further comprises:
determining that the user response corresponds to a jump to an anchor node, wherein the anchor node is pre-determined by a user selection;
identifying the anchor node from which the first node is a descendant in the decision tree; and
selecting the identified anchor node as the second node.

5. The method of claim 1 further comprising:
receiving a subsequent user response corresponding to the second question;
determining that the subsequent user response corresponds to a request to select a different node other than the second node;
identifying a third node related to the first node; and
displaying a third question to the user that corresponds to the third node.

6. The method of claim 1 further comprises:
determining that the user response corresponds to a different node in a different decision tree;
adding an stack entry to a global conversation stack that identifies the different decision tree in response to the determination; and
selecting the different node in the different decision tree as the second node.

7. The method of claim 6 further comprising:
receiving a subsequent user response corresponding to the second question;
determining that the subsequent user response enables a continuation of traversing the decision tree;
removing the entry from the global conversation stack; and
providing the question corresponding to the first node and the set of answer selections to the user.

8. An information handling system comprising:
one or more processors;
a memory coupled to at least one of the processors;
a set of computer program instructions stored in the memory and executed by at least one of the processors in order to perform actions of:
providing a question and a set of answer selections to a user, wherein the question corresponds to a first node in a decision tree, and wherein at least a portion of the set of answer selections corresponds to a branch from the first node to one of a plurality of connecting nodes that directly connect to the first node;
analyzing a user response to the question, wherein the user response corresponds to a second node that is different than one of the plurality of connecting nodes; and
displaying a second question to the user that corresponds to the second node.

9. The information handling system of claim 8 wherein, prior to providing the question and the set of answer selections to the user, the one or more processors perform additional actions comprising:
evaluating a question received from the user against a plurality of decision trees, wherein each of the plurality of decision trees includes a plurality of nodes; and
selecting the decision tree from the plurality of decision trees and the first node from the plurality of nodes based on the evaluation of the question.

10. The information handling system of claim 8 wherein the one or more processors perform additional actions comprising:
displaying a position indicator to the user that identifies a position of the second node in the decision tree.

11. The information handling system of claim 8 wherein the one or more processors perform additional actions comprising:
determining that the user response corresponds to a jump to an anchor node, wherein the anchor node is pre-determined by a user selection;
identifying the anchor node from which the first node is a descendant in the decision tree; and
selecting the identified anchor node as the second node.

12. The information handling system of claim 8 wherein the one or more processors perform additional actions comprising:
receiving a subsequent user response corresponding to the second question;
determining that the subsequent user response corresponds to a request to select a different node other than the second node;
identifying a third node related to the first node; and
displaying a third question to the user that corresponds to the third node.

13. The information handling system of claim 8 wherein the one or more processors perform additional actions comprising:
determining that the user response corresponds to a different node in a different decision tree;
adding an stack entry to a global conversation stack that identifies the different decision tree in response to the determination; and
selecting the different node in the different decision tree as the second node.

14. The information handling system of claim 13 wherein the one or more processors perform additional actions comprising:
receiving a subsequent user response corresponding to the second question;
determining that the subsequent user response enables a continuation of traversing the decision tree;
removing the entry from the global conversation stack; and
providing the question corresponding to the first node and the set of answer selections to the user.

15. A computer program product stored in a computer readable storage medium, comprising computer program code that, when executed by an information handling system, causes the information handling system to perform actions comprising:
providing a question and a set of answer selections to a user, wherein the question corresponds to a first node in a decision tree, and wherein at least a portion of the set of answer selections corresponds to a branch from the first node to one of a plurality of connecting nodes that directly connect to the first node;
analyzing a user response to the question, wherein the user response corresponds to a second node that is different than one of the plurality of connecting nodes; and
displaying a second question to the user that corresponds to the second node.

16. The computer program product of claim 15 wherein, prior to providing the question and the set of answer selections to the user, information handling system performs further actions comprising:
evaluating a question received from the user against a plurality of decision trees, wherein each of the plurality of decision trees includes a plurality of nodes; and
selecting the decision tree from the plurality of decision trees and the first node from the plurality of nodes based on the evaluation of the question.

17. The computer program product of claim 15 wherein the information handling system performs further actions comprising:
displaying a position indicator to the user that identifies a position of the second node in the decision tree.

18. The computer program product of claim 15 wherein the information handling system performs further actions comprising:
determining that the user response corresponds to a jump to an anchor node, wherein the anchor node is pre-determined by a user selection;
identifying the anchor node from which the first node is a descendant in the decision tree; and
selecting the identified anchor node as the second node.

19. The computer program product of claim 15 wherein the information handling system performs further actions comprising:
receiving a subsequent user response corresponding to the second question;
determining that the subsequent user response corresponds to a request to select a different node other than the second node;
identifying a third node related to the first node; and
displaying a third question to the user that corresponds to the third node.

20. The computer program product of claim 15 wherein the information handling system performs further actions comprising:
determining that the user response corresponds to a different node in a different decision tree;
adding an stack entry to a global conversation stack that identifies the different decision tree in response to the determination;
selecting the different node in the different decision tree as the second node;
receiving a subsequent user response corresponding to the second question;
determining that the subsequent user response enables a continuation of traversing the decision tree;
removing the entry from the global conversation stack; and
providing the question corresponding to the first node and the set of answer selections to the user.
